(19) United States
(12) Patent Application Publication
(10) Pub. No.: US 2009/0128705 A1
(43) Pub. Date: May 21, 2009

(54) VIDEO PROCESSING APPARATUS AND GAMMA CORRECTION METHOD THEREOF

(76) Inventors: Dong-Hyun YEO, Goyang-si (KR); Jong-Hyon Park, Cheonan-si (KR); Jae-Hyoung Park, Asan-si (KR)

Correspondence Address: Haynes and Boone, LLP;IP Section, 2323 Victory Avenue, SUITE 700, Dallas, TX, 75219, US

(21) Appl. No.: 12/255,548

(22) Filed: Oct. 21, 2008

(30) Foreign Application Priority Data
Nov. 21, 2007 (KR) 10-2007-0119270

(51) Int. Cl. H04N 5/202

(52) U.S. Cl. 348/674; 348/E09.054

(57) ABSTRACT

Provided is a video processing apparatus comprising a storage unit and a gamma correction unit. The storage unit stores a plurality of representative values of brightness to perform a gamma correction to a video signal. The gamma correction unit calculates a difference value between two adjacent representative values among the plurality of representative values, and performs gamma correction on the video signal based on the plurality of representative values and the plurality of difference values.

### CROSS-REFERENCE TO RELATED APPLICATION

This application claims priority from Korean Patent Application No. 2007-0119270 filed on Nov. 21, 2007 in the Korean Intellectual Property Office, the disclosure of which is incorporated herein by reference.

### BACKGROUND OF INVENTION

1. Field of Invention

The present invention relates to a video processing apparatus which performs gamma correction on the basis of a representative value of previously stored brightness, and a gamma correction method thereof.

2. Description of the Related Art

In a video processing apparatus such as a television or the like, gamma correction may be applied to an image. When this is done, if all the data for the gamma correction has to be stored in the memory, a fairly large memory may be needed. Hence, to prevent the memory size from increasing unreasonably, interpolation may be used to reduce the amount of data.

During interpolation, the video processing apparatus uses a representative value of a gamma curve and a difference value between the representative values in order to perform the gamma correction. The representative value is brightness corresponding to each gray scale in the gamma curve, and the difference value refers to a difference between two adjacent representative values in the gamma curve.

That is, the video processing apparatus stores the representative value and the difference value between the representative values, and performs gamma correction together with the interpolation by using a brightness value of a video signal. For example, an LCD TV includes a timing controller which timing-controls a source driver and a gate driver to drive an LCD panel. The timing controller includes a ROM (read only memory) to store therein the representative value and difference value of the gamma curve. The timing controller performs interpolation with respect to the representative value, difference value and brightness value of the inputted video signal per pixel according to a particular formula, and the gamma correction is implemented here.

However, the conventional video processing apparatus uses the memory inefficiently by storing the representative value and difference value together in the memory. Particularly, if the number of data bits of the representative value and difference value increases to improve hue and image quality, more capacity of the memory is required and manufacturing costs rise accordingly.

### SUMMARY OF THE INVENTION

In one aspect, the present invention provides a video processing apparatus which takes up less memory space to perform gamma correction, thereby reducing costs. In another aspect, and the invention is a gamma correction method usable with a video processing apparatus.

Also, it is another aspect of the present invention to provide a video processing apparatus which calculates a difference value by using previously stored representative values, and a gamma correction method used by the video processing apparatus.

The foregoing and/or other aspects of the present invention can be achieved by providing a video processing apparatus that includes: a storage unit which stores a plurality of representative values of brightness to perform a gamma correction to a video signal; and a gamma correction unit which calculates a difference value between two adjacent representative values among the plurality of representative values, and performs a gamma correction to the video signal based on the plurality of representative values and the plurality of difference values.

The gamma correction unit may calculate the difference values between the representative values and values that are one clock-shifted from the representative values.

The video processing apparatus may also include an SRAM (static random access memory) which stores the plurality of representative values and the plurality of difference values, wherein the gamma correction unit stores values that are shifted by two clocks from the representative values and the difference values in the SRAM.

The gamma correction unit may include an interpolation performing unit which performs an interpolation based on the representative values, the difference values and brightness values of the video signal.

The video processing apparatus may include a dithering unit which performs dithering to the gamma-correction data.

In another aspect, the invention is a gamma correction method of a video processing apparatus. The gamma correction method includes: calculating a difference value between two adjacent representative values of a plurality of representative values of brightness that are stored to perform a gamma correction to a video signal; and performing a gamma correction to the video signal based on the plurality of representative values and the plurality of difference values.

Calculation of the difference values may include shifting the representative values by one clock.

The method may also include storing the difference values and the values that are shifted by two clocks from the representative values.

The method may also include performing an interpolation based on the representative values, the difference values and the brightness values of the video signal.

The method may also include dithering the gamma-corrected data.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram of a video processing apparatus according to an exemplary embodiment of the present invention;

FIG. 2 is a timing diagram of calculating a difference value in the video processing apparatus according to the exemplary embodiment of the present invention;

FIG. 3 is a block diagram of a video processing apparatus according to another exemplary embodiment of the present invention; and

FIG. 4 is a flowchart to describe an operation of the video processing apparatus according to the exemplary embodiment of the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

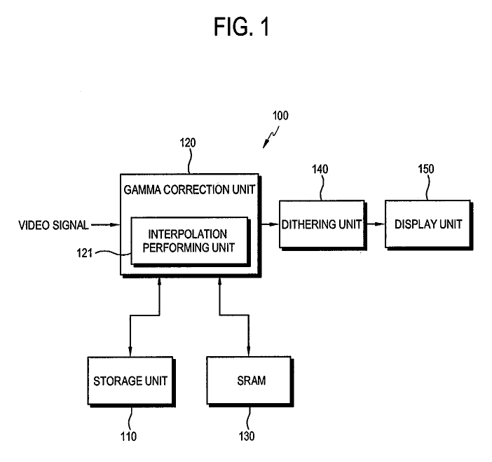

FIG. 1 is a block diagram of a video processing apparatus 100 according to an exemplary embodiment of the present invention. The video processing apparatus 100 may perform gamma correction by using a previously stored representative value of brightness. For example, the video processing apparatus 100 may include a TV, a monitor and the like.

As shown therein, the video processing apparatus 100 may include a storage unit 110, a gamma correction unit 120, an SRAM (static random access memory) 130, a dithering unit 140 and a display unit 150.

The storage unit 110 stores therein a plurality of representative values of brightness to perform gamma correction to a video signal. The plurality of representative values is a sampling of nonlinear gamma curves. Each of the representative values includes a brightness value corresponding to a gray scale selected from the gamma curve to be sampled. For example, brightness of a gamma curve having 1024*12 bits may be sampled and reduced to 256*12 bits. Here, data about the sampled 256*12 bits become a representative value. The storage unit 110 may include a ROM in a timing controller.

The gamma correction unit 120 calculates a difference value between two adjacent representative values among the plurality of representative values, and performs a gamma correction to a video signal based on the plurality of representative values and the plurality of difference values. More specifically, the gamma correction unit 120 calculates a difference value by using a representative value and a value which is shifted by one clock from the representative value. The gamma correction unit 120 also stores a value which is two block-shifted from the representative value and a difference value in the SRAM 130. The SRAM 130 will be described later.

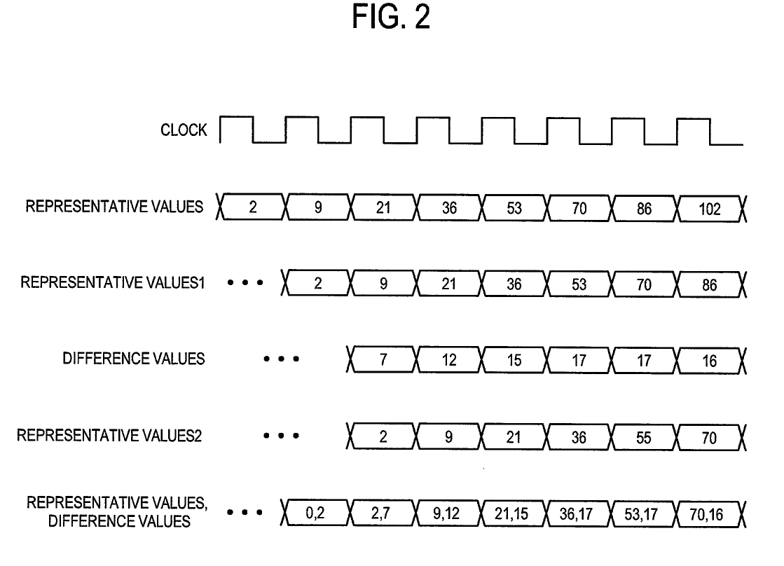

As shown in FIG. 2, the gamma correction unit 120 reads a representative value stored in the storage unit 110 and shifts the value by one clock. The gamma correction unit 120 then calculates a difference value between consecutive representative values 1. After calculating a representative value 2 with a representative value shifted by two clocks, the gamma correction unit 120 stores the difference value and the representative value 2 in the SRAM 130. As the representative value having a memory address of zero is zero, the initially stored representative value and difference value are 0 and 2.

An interpolation performing unit 121 is included in the gamma correction unit 120 and may perform interpolation based on a representative value, a difference value and a brightness value of a video signal. For example, a timing controller of an LCD TV includes the interpolation performing unit 121. The interpolation performing unit 121 calculates a representative value, a difference value and a brightness value of an inputted video signal per pixel according to a particular formula to perform interpolation. Within this process, the gamma correction is performed, too. That is, the interpolation to determine a difference value between a plurality of representative values is performed at the same time the gamma correction is applied to the video signal.

The SRAM 130 stores a plurality of representative values and a plurality of difference values. The SRAM 130 stores the plurality of representative values stored in the storage unit 110 and the plurality of difference values calculated by the gamma correction unit 120, as a lookup table.

The dithering unit 140 performs dithering on the gamma-corrected data. The dithering unit 140 performs dithering to a video signal having a first data bit to be converted into a video signal having a second data bit smaller than the first data bit. That is, dithering is a process for minimizing errors generated when the data bits are reduced. For example, if video signal data that are gamma-corrected by the gamma correction unit 120 include 12 bits and if output data bits of the LCD panel are 10 bits, the 12-bit data should be reduced to 10 bits. To minimize the errors generated during the bit-reducing process, the video signal may be dithered. If the LCD panel may process a 12 bit video signal, the dithering process is unnecessary. There are a number of well-known dithering methods that may be used in this process.

The display unit 150 displays a video based on video data processed by the gamma correction unit 120. The display unit 150 may include a CRT (cathode ray tube), an LCD (liquid crystal display), a PDP (plasma display panel) and the like.

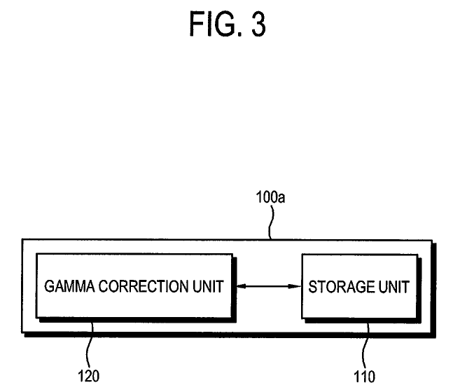

FIG. 3 is a block diagram of a video processing apparatus 100a according to another exemplary embodiment of the present invention. As shown therein, the video processing apparatus 100a may include only a storage unit 110 and a gamma correction unit 120. Similar or equivalent descriptions will be avoided.

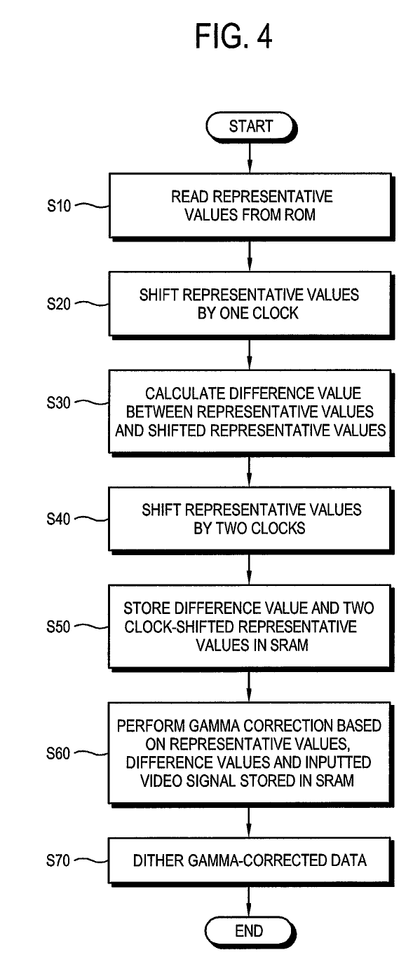

Hereinafter, a control method of the video processing apparatus 100 according to the exemplary embodiment of the present invention will be described with reference to FIG. 4.

First, the video processing apparatus 100 reads the representative values that are previously stored in the ROM (S10). For example, brightness of the gamma curve having 1024*12 bits may be sampled and reduced to 256*12 bits. The data about the sampled 256*12 bits become a representative value.

The video processing apparatus 100 shifts the representative values by one clock (S20). The video processing apparatus 100 then calculates the difference value between the representative values and the shifted representative values (S30). The video processing apparatus 100 shifts the representative values by two clocks (S40). Then, the video processing apparatus 100 stores the difference value and the two clock-shifted representative values in the SRAM 130 (S50).

As shown in FIG. 2, the gamma correction unit 120 reads the representative values stored in the storage unit 110 and shifts the representative values by one clock. The gamma correction unit 120 calculates the difference value between the representative values and the one clock-shifted representative values 1. After shifting the representative values by two clocks to calculate the representative values 2, the gamma correction unit 120 stores the difference value and the representative values 2 in the SRAM 130. The representative values having a memory address of zero is zero. Thus, the initially stored representative values and difference value are 0 and 2.

The video processing apparatus 100 performs gamma correction based on the representative values, the difference values and the inputted video signal stored in the SRAM 130 (S60). The interpolation performing unit 121 calculates the representative values, the difference values and the brightness values of the inputted video signal per pixel according to a particular formula to perform the interpolation. Within this process, the gamma correction is implemented.

The video processing apparatus 100 performs dithering on the gamma-corrected data (S70). For example, if the video signal data that are gamma-corrected by the gamma correction unit 120 are 12 bits and if the output data bits of the LCD panel are 12 bits, the 12 bit data should be reduced to 10 bits. To minimize errors generated during the data-reducing process, the video signal may be dithered.

As described above, the present invention provides a video processing apparatus which takes up less memory to perform gamma correction and reduces costs, and a gamma correction method thereof.

Also, the present invention provides a video processing apparatus that calculates a difference value by using previously stored representative values, and a gamma correction method thereof.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A video processing apparatus, comprising:
a storage unit which stores a plurality of representative values of brightness to perform a gamma correction to a video signal; and
a gamma correction unit which calculates difference values between two adjacent representative values of the plurality of representative values, and performs gamma correction on the video signal based on the plurality of representative values and the plurality of difference values.

2. The video processing apparatus according to claim 1, wherein the gamma correction unit calculates the difference values between the representative values and values that are one clock-shifted from the representative values.

3. The video processing apparatus according to claim 2, further comprising an SRAM (static random access memory) which stores the plurality of representative values and the plurality of difference values, wherein the gamma correction unit stores values that are shifted by two clocks from the representative values and the difference values in the SRAM.

4. The video processing apparatus according to claim 3, wherein the gamma correction unit further comprises an interpolation performing unit which performs an interpolation based on the representative values, the difference values and brightness values of the video signal.

5. The video processing apparatus according to claim 4, further comprising a dithering unit which performs dithering on the gamma-correction data.

6. A gamma correction method of a video processing apparatus, the gamma correction method comprising:
calculating a difference value between two adjacent representative values among a plurality of representative values of brightness that are stored to perform a gamma correction to a video signal; and
performing a gamma correction to the video signal based on the plurality of representative values and the plurality of difference values.

7. The gamma correction method according to claim 6, wherein the calculating of the difference values comprises shifting the representative values by one clock.

8. The gamma correction method according to claim 7, further comprising storing the difference values and the values that are shifted by two clocks from the representative values.

9. The gamma correction method according to claim 8, further comprising performing an interpolation based on the representative values, the difference values and the brightness values of the video signal.

10. The gamma correction method according to claim 9, further comprising dithering the gamma-corrected data.
